(19) United States
(12) Patent Application Publication
(10) Pub. No.: US 2017/0113749 A1
(43) Pub. Date: Apr. 27, 2017

(54) Bike Grocery Bag Porter

(71) Applicant: William P Neidinger, Incline Village, NV (US)

(72) Inventor: William P Neidinger, Incline Village, NV (US)

(21) Appl. No.: 15/167,762

(22) Filed: May 27, 2016

Related U.S. Application Data
(60) Provisional application No. 62/167,806, filed on May 28, 2015.

(51) Int. Cl. B62J 9/00

(52) U.S. Cl. CPC B62J 9/001

(57) ABSTRACT

These devices are screens and hooks to be attached to a rack, or bike frame itself. In all instances, rack and frame are available in market place by others. As a practical matter, best racks would be marketed with product, with product claims, recommended use and general instructions starting there, but other racks could be used with information to customer that capacities and performance may be more limited. The handles of grocery bags are engaged on gently rounded hooks and/or handlebars. The bike screens hang down outside the wheel to prevent the grocery bags from engaging on the tread or spokes of wheels of the bicycle. The screens are configured to both visually and mechanically outline the maximum available hanging space. The hooks are configured to provide maximum utilization of that available hanging space for all most commonly used sizes and configurations of grocery and other shopping bags.

### BACKGROUND OF THE INVENTION

In the United States, and all other markets, bicycles are used for transportation by a significant portion of the population. Their use is increasing as a convenient and affordable means of transportation. Bicycles are used for many local activities such as going to the store for shopping. For such activities, cargo space on bicycles is generally at a premium. Regardless of exact configuration and dimensions, the most commonly used bags—particularly grocery bags—when full, they tend to be remarkably uniform in size and general shape. Space for loading them could and should be allocated accordingly, though as of the date of this submission, that has not happened in the marketplace yet.

In most of the rest of the world, and increasingly now in America, people in almost all walks of life daily carry “just in case bags.” Particularly the ones carried discreetly in clothes pockets tend to be the same size, configuration, and material as typical American plastic grocery bags, or close. Thus the same issues arise for users when they return to their bicycles.

I make no claim to be the first to try to carry grocery and other bags on a bicycle, or even to be the first to make an accessory to better facilitate that. Approximately a year after the first “safety bicycle”* came into use, such a sweeping claim would no longer be valid for anybody, and that was about a hundred years ago. And now virtually every device put up for sale anywhere in the world is accessible somehow through the internet. Yet still a most helpful device, or anything that hit most of such parameters was not anywhere on the web, nor was it in any of recent patent submissions I could find. People who want to badly enough are already hanging bags from handlebars and other hooks—I know, I have been one of them; and I, like everybody else, was dealing with, and living with the shortcomings. Many would say the solution I was looking for is nonexistent and not possible. From my background as an Architect, I sought and found a solution, as nobody did before, that is a systematic application of the available “real estate” on the sides of a bike—exactly what all is left over after all the functional “setbacks” and “easements” of bicycle component and rider motion and use. Application of materials and construction most similar to that which is on bicycles already, presented technical challenges which has lead to the development of proprietary manufacturing processes, not patentable, but non-disclosed. * The name “safety bicycle” was coined to refer to bicycles with two wheels approximately the same size, one in front of the other approximately the diameter of the riders inseam (if he or she was wearing pants), with the rider positioned in between. Today we call these “English Racers” or “Mountain Bikes” or “Hybrids,” etc.

Most devices available for sales have a relatively small capacity. On a trip to grocery store most people want to take advantage of all the current specials in one trip. When the bicycle is a healthy lifestyle choice, then usually a rider is also putting some effort into healthy eating choices, and would also want to buy all the ingredients for all the healthy recipes for a balanced diet at one time. They would be cooking more from scratch, which usually translates into bulkier grocery items.

While someone is exercising up a sweat often enough to not be dependent on a motor vehicle, or they don't have one available, they are going to want to combine trip with other stores nearby—more bags. As one is traveling at a human pace on roads and other paths conducive—usually on the side roads—one will go right by farmers' stands, yard sales, etc. and it would be nice to have the capacity to the advantage of that as well. Buy local after all! Going back, on a hot day, on another loaded 20 miles trip (30 km) is not inspiring to most people. In short, a two bags limit is a pain; even a four bag limit sometimes is a pain. The mental model I constructed had room for up to ten full grocery sized bags with many options for less than that. That actually matched the physical space and dimension I had to work with, and the prototype I built.

With most existing devices, the rider goes out into the parking lot and has to repack all groceries—into saddlebags or other containers, and whatever doesn't fit has to be juggled with a hand off handlebars on the road. In many cases, the rider discovers that devices with larger capacity, and almost as durable as the bike itself, can cost more than the bike itself; or the “device” is a whole bike permanently modified at even greater expense—and less suited for other uses. Some devices have detachable bags or baskets that could be brought into a grocery store. That is a help, but the capacity is generally quite limited, which still leads to more fussing with packing; and is not maximized in any of them. That also generally comes at a higher cost, and if part of it breaks irreparably, what do you do with the rest of it?

Available rigid containers offered a few more options for space; but with all the drawbacks mentioned for detachable bags or baskets, plus such items available are bulky and not aerodynamic or collapsible and flimsy. Like many people, I have also tried tying a large milk crate to a commonly available platform, I discovered that with any weight inside it (even <10 lbs or <5 kg), it was almost impossible to keep it from shifting around as I rode, and the platform sagged until it touched, and wore on, the tire. In short, almost any typical improvised solution exposes a series of mechanical weaknesses. In conjunction with my Bike Grocery Bag Porter, I now use a most heavy duty platform, it bypasses all the bikes standard and generally feeble connections, and it probably could support another adult in a pinch, although the manufacturer doesn't rate it for that and I'll pass on using it for that.

My proposal begins with almost all the issues mentioned in other marketplace devices and other patents pending (see disclosure statement at end of this section) done and market tested already—building off the best of existing products by others—and within limited new fabrication. The only new load bearing parts are the hooks themselves and that is not a high stress or compromised assembly. The hooks are configured to provide maximum utilization of that available hanging space for all most commonly used sizes and configurations of grocery and other shopping bags. They are designed to avoid sharp edges bearing on bag handles. The screens are configured to both visually and mechanically outline the maximum available hanging space. I did not opt for fold-away screens. If the form follows function well enough, it does not need to be hidden; and by keeping them rigid, the whole perimeter is potential connection points for different bike configurations as need be, the connected hook load is dissipated, and I have no small connection points, hinges, or any other small moving parts, exposed to mechanical stress. Also one of the objects of the present invention is to support an arrangement for holding bags on a bicycle such that the overall center of gravity of the bicycle with load is not raised, creating issues with ease of operation and safety. So I left all functions visible with aerodynamic form following said functions in a flowing pleasant manner and since they are flat against bike, they don't take up space or bulk anyway. The front screens have no hooks as the handlebars on most bikes can serve that function; and they are shallower because in virtually every bicycle configuration, available in marketplace, there is more space between the handlebars and the front wheel than there is between a rear platform and the rear wheel. I opted away from platform construction when I realized that a very strong platform that would connect with almost all full-sized bike configurations would require too many different kinds of parts to be manufactured by one company. If one has to buy parts, in their final configuration, from another company anyway, why not let them engineer and warranty it. That decision also enables me to market to all the bicyclists who already have platforms which they don't want to throw away.

In recent times, the bags that the vast majority of shopping trips involve are either sheet polymer bags which have handles formed by punching out a hand-hold near the open top of the bag, and a single side pleated seam on the bottom, or Kraft paper bags with glued-on handles and a rectangular bottom, or now, more and more, people, stores, municipalities, and states are insisting on press-fused cloth bags with punched out hand-holds near the open top and usually a rectangular bottom. Regardless, of their varying dimensions and configuration when laying flat on a table, I have measured a variety of test-packs (besides actual groceries and found that when they are full of various groceries, unless one has something unusually large item in one, they all take the shape of lumpy ovals 11 inches or 28 cm wide by 16 inches or 41 cm tall. Hang them from hooks same distance apart and they hang straight down 22 inches or 56 cm wide—which happens to be almost exactly the distance from just clearing the back of a foot on a bicycle petal to the back of a rear tire on a full sized bike (wheels 24-29 inches or about 600-700 mm). Space the hooks any wider and the rider is either hitting then with back of foot or they are sticking out the back more than a little. If you make the hooks closer, full bags are not plumb (front to rear) and thus stick out and one has the same problem. Between that and the handlebars, there are spaces for six full bags. If sometime even that is not enough, then with the middle hook and the outer handle bars, one could place and carry four more lightly packed full bags on the way home from a more ambitious trip (the last bags need to be lighter on the back so they don't displace and spread the two already on the outer hooks, and on the front much weight from additional outer bags makes safe steering more difficult). And of course the different hook locations allow options for larger bags. How does the rider know his placement of a larger bag will work or which hook it needs to move to?—The perimeter of the screen is the perimeter of the free space on the side of the bicycle. This is the essence of what is completely missing from ALL types of present marketplace devices—and with that space at such a premium—there is the definition of possible cargo capacity and maximum utility—there is the definition of how you will get your acquisitions home.

The cost of having more bags on hand is negligible, as is the load. Regarding weight: for a heavy grocery bag, if it is plastic, add another layer of bag if the hand-hold stretches at all in your hand (×2, ×3—if hand hold still is strained beyond safe passage over a long bumpy road—divide the load—after all these devices were expressly designed to allow space for up to ten bags). The glued handles of paper bags hold a little less than that, and the cloth bags hold somewhat more.

With all the improvisations for bicycle cargo carrying one can see in a urban setting, or rural setting less frequently, the need for rack and front fork mounted bike grocery bag porters for carrying bags and similar items should be self-evident.

### SUMMARY OF THE INVENTION

These devices consist of hooks and screens for transporting multiple shopping bags (usually grocery or same sized other) in conjunction with platform by others directly on bicycle assembly. The functional application I am seeking protection for here is not for the idea of any hooks or screens themselves because a) in generic form the idea is past being unique; b) that in itself was never the impetus or the central focus of my work; c) that is not the idea and the brand that would seek to protect for future investors; d) nor in itself is it the core idea I would want focus on sharing and evangelizing. The core of what I believe is most worth branding, and even evangelizing if you will, and wholly missing from the market place, is the expressed demarcation of functional “real estate” on what is, to begin with, a functional device of transportation, the bicycle itself. The products I seek to protect for future investors are systems for utilitarian demarcation and functional expression of maximized cargo carry for common forms of holding common cargo, bringing that to market, and sharing that with the world. This generally involving groceries (as other cargo needs would generally involve less peak capacity). The brand is the aerodynamic form following function for a line of products, here bicycle products. The flowing demarcation of kinetic functional limits creates objects which can speak for themselves—the defining curves are part of the functional definition of these products capacity and therefore, the core utility that I seek protection from near copycats. We wouldn't mind competition generally, but if someone else comes along and they want to guarantee the same maximum capacity within the same rather tight functional constraints, they will not only use components with the same function, but they would use at least many of the same component shapes as well, and thus we would be facing an undifferentiated product that we first created, promoted, and engineered out of our own time, our own pockets and sweat labored into market.

It is thus a purpose and advantage of this invention to provide screens in the rear, which can be mounted on a rack over the rear wheel of the bicycle which are configured for keeping multiple grocery bags and similar items out of exposure to mechanical damage from the operation of the rear wheel, pedals and contact with other objects.

It is a further purpose and advantage of this invention to provide rear-mounted bike screens an array of smooth rounded hooks upon which the handles of grocery bags can safely be engaged.

It is another purpose and advantage of this invention to provide rear-mounted bike screens which are configured to both visually (for load placement utility) and mechanically (for operational utility) outline the maximum available hanging space. The hooks are configured to provide maximum utilization of that available hanging space for all most commonly used sizes and configurations of grocery and other shopping bags.

It is thus a purpose and advantage of this invention to provide screens in the front, which can be mounted over the front wheel of the bicycle which are configured for keeping grocery bags and similar items out of exposure to mechanical damage from the operation of the front wheel and contact with other objects.

It is a further purpose and advantage of this invention to provide that front screens will be fully functional on a bicycle a little smaller than what will best handle multiple standard sized grocery or other bags in the rear, or a bike with a “Banana Seat” with same wheel size or a little smaller. The front screens proposed for a full-sized safety bicycle—and built as prototypes—are fully functional in this application as well—as defined, and built in prototype here. Bikes with Banana Seats tend to appear somewhat curvier, both seat and frame—as the front screen, following the available space configured at the top of the front wheel—is also in a congruent fashion.

It is another purpose and advantage of this invention to provide options of the advantages inherent with only the rear-mounted bike screens, or the advantages inherent with only the front-mounted screens, or both, for loading and supporting grocery bags and similar items, which can be efficiently and economically provided so as to enhance the utility of using a bicycle for grocery and other shopping.

The features of this invention which are believed to be novel are mechanically defined with particularity in the included claims. Those features are described and highlighted in the description background and summary. The present invention, both as to its organization and manner of operation, may be best understood by reference to the accompanying drawings, taken in conjunction with the afore mentioned descriptions.

### DESCRIPTION OF THE PREFERRED EMBODIMENT

The bike hooks and screens for supporting grocery bags and similar items of this invention are dimensionally generally indicated in the claims and diagrams 1, 2 and 3. But for reasons that 1) the size and general shape of full grocery bags or similar other shopping bags are so uniform, and 2) regardless of size of bicycle, for reasons of material efficiency, together with 3) the bike—not taking any extra space, 4) no corresponding extra exposure to mechanical damage, and 5) general aesthetic considerations, the screen assemblies want to be just large enough for the bags and no larger. So the preferred dimensions actually planned for preliminary production—and incorporated in working prototype—generally are specific and not ranges:

The rear bicycle screens contain curved loops along the top edge for engaging shopping bags approximating a double “S” configuration with all radii being ¾ inch or 2 cm (profile dimension a)—(or some form of segmented arcs). Two outer loops are spaced 11 inches or 28 cm apart (b) for bags to rest against each other but still remain vertically plumb (from side view). A third loop, centered on the other two, may be included for a third bag, more lightly packed, to plumb out from the other two, or accommodate a single extra wide bag.

The rear bicycle screens are configured as roughly parallelograms 22 inches or 56 cm wide (c) by 14 inches or 35 cm high (d) bounded front and rear by “S” curves sloping away from connections at top bar towards rear of bike, order to follow and clear the back of pedaling foot motion at front of screen, and to follow the rear tire at the back of screen, and bounded top and bottom with horizontal bars. The radii of the side “S” curves are all to be 20 inches or 51 cm (e)—(or approximation in some form of segmented arcs).

The front bicycle screens are to be outlined in roughly the shape of an American football, bounded top and bottom by curves with radii to be 20 inches or 51 cm (f), with overall dimensions of 16 inches or 41 cm wide (g) by 9 inches or 23 cm high (h). The inner curves shown in diagram 2—rear half configured to help form a moment connection to any angle bike fork and the front half for perimeter stock to cross face of fork at least twice (mechanical reinforcing)—are to be concentric and comprised of radii of 4½ inches or 114 mm (i) and 6 inches or 152 mm (j) respectively. With all curves—or approximation in some form of segmented arcs.

On first production, all other corners are to be radiused at 1½ inches or 4 cm (k)—about double the hook radii. Again with all curves—or approximation in some form of segmented arcs.

The rear screen dimensions—22 inches or 56 cm wide—happens to be almost exactly the distance from just clearing the back of a foot on a bicycle petal to the back of a rear tire on a full sized bike (wheels 24-29 inches or about 600-700 mm), with the bottom of the rear screen conveniently ending up just above the rear axle. Have no immediate plans for a scaled down version for children's bikes because there are virtually no useful scaled down bags in the market today to fit such a device to. When product line fully takes off, we may possibly manufacture or as least market such bags ourselves.

The front screens will be fully functional on a bicycle a little smaller than what will best handle multiple standard sized grocery or other bags in the rear, or a bike with a “Banana Seat” with same wheel size or a little smaller. The front screens proposed for a full-sized safety bicycle—and built as prototypes—are fully functional in this application as well—as defined, and built in prototype here. Bikes with Banana Seats tend to appear somewhat curvier, both seat and frame—as the front screen, following the available space configured at the top of the front wheel—also is in a congruent fashion.

### ABSTRACT OF THE DISCLOSURE

Regarding previous art—none known, at least for full store shopping bags, and especially the capacity of a full standard U.S. shopping cart, or small car trunk. Regarding pending art—by far, the closest previous patent submissions are US20100327034 A1 and US20110132949 (both still under review when I looked), the first also published as CA2745921A1, DE102007059219A1, DE102007059219B4, EP2229311A1, EP2229311B1, WO2009071328A1; and the second also published as CA2782526A1, CN102630206A, CN102630206B, EP2509853A1, EP2509853A4, U.S. Pat. No. 8,453,895, WO2011071517A1.

The first application is so broad that an argument could be made to claim almost any configuration of back of bicycle and shopping bags together—with none of those applications developed enough for a consumer to identify anything even close to a measurable, let alone useful, product. I would submit that appears to be un-patentable because millions, probably billions of people over the last hundred years have found some way to hang a shopping bag on a bike (myself included—decades ago). I submit that unless one has an expressed functional goal—as here with maximum usable capacity, without creating new problems, ie. operational, mechanical, aerodynamic, safety, aesthetic, or excessive cost issues—then one cannot have a design solution.

The second is somewhat more focused. It has one bar or post in the middle a platform of undefined dimensions, undefined relation to usable space and undefined connections, let alone undefined materials and undefined full assembly. What is defined is a different direction from the Bike Grocery Bag Porter—one connection point with up to two bags reaching over a platform—but two bags not completely full (have to allow for reaching over platform). And nobody even tried to identify how more than one bag bottom can actually rest next to each other—and therefore fit in maximum available space. The object of that design's moving parts was to discretely fold out of the way—only aesthetically somewhat—they are still there; if they would now claim hanging space to back of back tire, then even when folded-up, most of their assembly will hanging out in open air behind the bike, stacked many layers high, made out of many small moving parts, to bounce along the rough road surfaces, which now have no function for the form to follow. Also a square post (so it can be surface flush “retractable”) puts the whole bags load against hard edges, also limiting what one can safely put in just two bags (rather then 10 full). None of the specific components in those previous submissions, or any other submission, have I ever wanted to use or duplicate.

### BRIEF DESCRIPTION OF THE DRAWINGS

FIG. 1 is a side elevation of a bicycle, with front and rear-mounted bike screens and hooks for supporting grocery bags and similar bags mounted thereon. Sample grocery bags dotted in.

FIG. 2 is a side profile of a rear-mounted bike screen and hooks with key dimensions as per claims referenced.

FIG. 3 is a side profile of a front-mounted bike screen with key dimensions as per claims referenced.

FIG. 4 is a promotional logo, which also happens to highlight some key utilitarian product related lifestyle benefits.

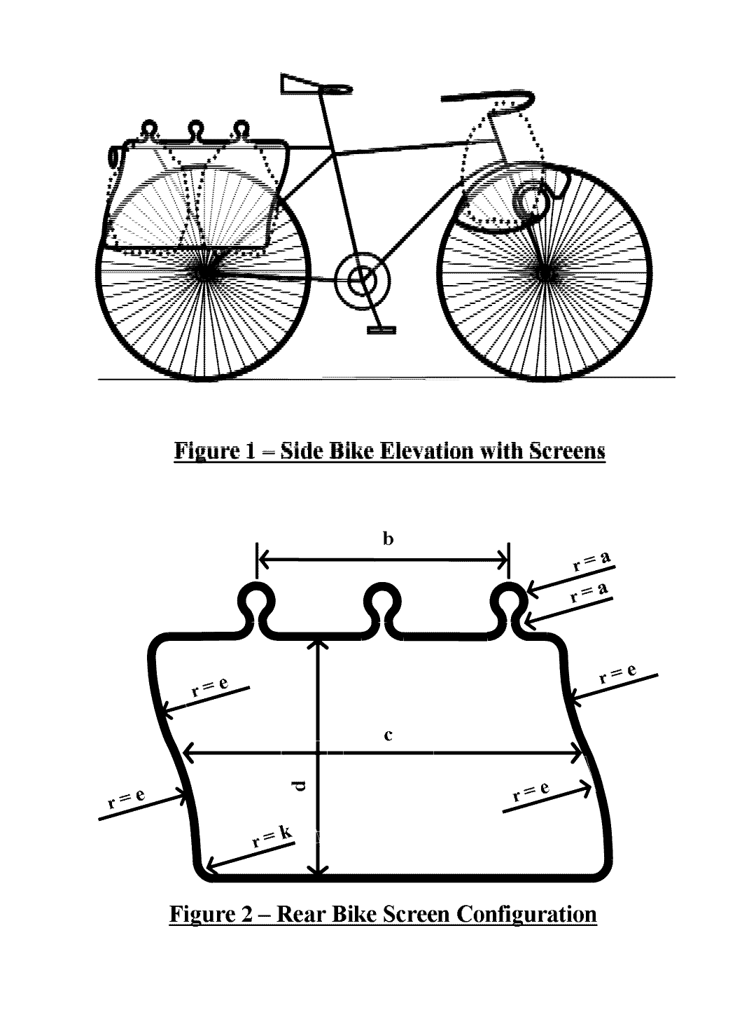

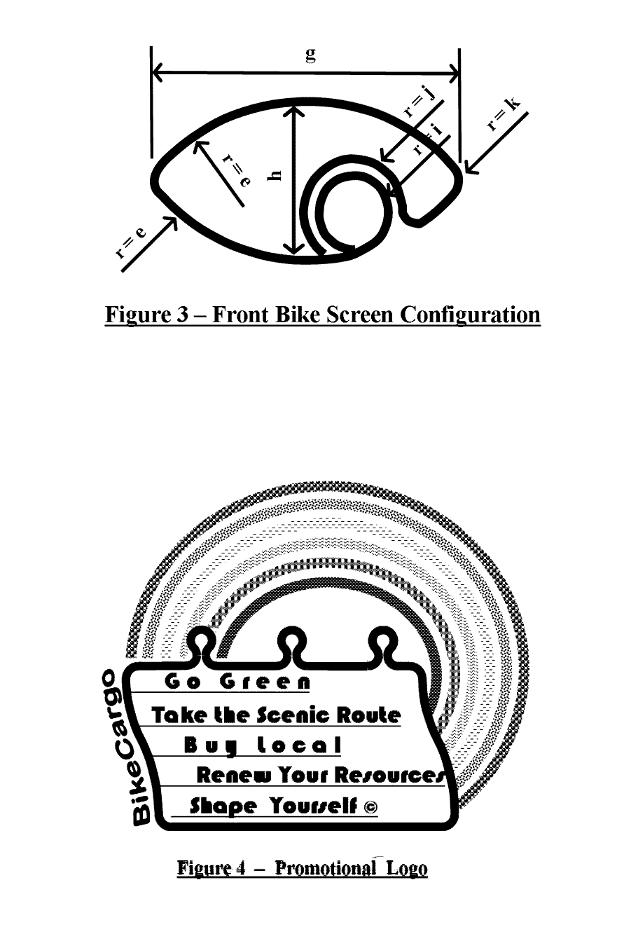

1. The number one claim is that these devices address an underserved utilitarian need, and fulfill a gaping hole in the current marketplace for bicycle cargo load maximizers. Of course, they are also easy to use—if they weren't, then they likely would not be fully utilized—and then they would no longer be cargo load maximizers. They are comprised of screens and hooks configured to both visually and mechanically outline and apply the maximum the available hanging space. All other claims are components and details to make that happen.

2. Screens and hooks for mounting to generic bicycle rear cargo platforms, of which there are many in the marketplace, by others, comprising: left and right screens mounted on said platform rack, said screens being positioned to inhibit shopping bags, engaged on said hooks, from engaging the rear wheel of the bicycle, said screens being mounted to said platform rack for easier attachment and detachment.

3. Front screens—left and right screens mounted on front fork, said screens being positioned to inhibit shopping bags, engaged on handlebars, from engaging front wheel.

4. The bicycle screens of claim 2 contain curved loops (or some form of segmented arc) along the top edge for engaging shopping bags approximating a double “S” configuration with radii of ⅜ to 2 inches or 1 to 5 cm (diagram dimension a). Two outer loops are spaced 8 to 13 inches or 20 to 33 cm apart (b) for bags to rest against each other but still remain vertically plumb (from side view). A third loop, centered on the other two, may be included for a third bag, more lightly packed, to plumb out from the other two, or accommodate a single extra wide bag.

5. The bicycle screens of claim 2 configured as roughly parallelograms 18 to 24 inches or 46 to 61 cm wide (c) by 12 to 17 inches or 30 to 43 cm high (d) bounded front and rear by “S” curves (or some form of segmented arcs) sloping backward from connections at top bar towards rear of bike, order to follow and clear the back of pedaling foot motion (heel) at front of screen, and to follow the rear tire at the back of screen (approximately—as configurations of full-sized bike in common use vary somewhat), and bounded top and bottom with horizontal bars. The radii of the side “S” curves are all 15 to 30 inches or 38 to 76 cm (e).

6. The bicycle screens of claim 3 are to be outlined in roughly the shape of an American football, bounded top and bottom by curves (or some form of segmented arcs) with radii to be 15 to 30 inches or 38 to 76 cm (f), with overall dimensions of 12 to 22 inches or 30 to 56 cm wide (g) by 6 to 16 inches or 15 to 41 cm high (h). The inner curves shown in diagram 3—rear half configured to help form a moment connection to almost any angle bike fork (working prototype uses rubber coated pipe clamps) and the front half of inner curves are for perimeter stock to cross face of fork at least twice for mechanical reinforcement—are to be concentric and approximate radii of 3 to 13 inches or 76 mm to 33 cm (i) and 4½ to 14 inches or 114 mm to 36 cm (j) respectively.

7. The bicycle screens of claim 2 and claim 3 could be framed by any sufficiently stiff and durable material; however, as a practical matter, in order to make claimed configurations, they will probably be metal rod stock. The screening material will be anything stiff enough or tight enough (and manufacture of different versions anticipated), being at least 50% open to air flow (exclusive of various logo panels), which will securely attach to the rod stock securely in an aesthetically presentable manner. All connections (other than rear screen hooks claimed above and front screen bar stock configuration for attachment to various bike front forks) are open to ongoing engineering and do not in themselves constitute any preliminary proprietary claims.
